(19) United States
(12) Patent Application Publication
(10) Pub. No.: US 2012/0185153 A1
(43) Pub. Date: Jul. 19, 2012

(54) METHOD FOR MANAGING THE TRANSITION BETWEEN TWO COMBUSTION MODES IN AN INTERNAL COMBUSTION ENGINE

(75) Inventors: Roberto Argolini, Milan (IT); Nicola Pio Sacco, Torino (IT); Alessandra Chianale, Alpignano (IT)

(73) Assignee: GM GLOBAL TECHNOLOGY OPERATIONS LLC, Detroit, MI (US)

(21) Appl. No.: 13/350,863

(22) Filed: Jan. 16, 2012

(30) Foreign Application Priority Data
Jan. 19, 2011 (GB) 1100883.6

(51) Int. Cl. F02D 41/26

(52) U.S. Cl. 701/103

(57) ABSTRACT

A method is disclosed for managing the transition between a lean combustion mode and a rich combustion mode, or vice versa. After a regeneration demand, or at the end of the regeneration phase, the air mass flow is modified from a first set point to a new set point within a predetermined time depending on the engine conditions. An air mass percentage value is cyclically calculated and compared with a target value. When the target value is reached, the fuel path is then suddenly switched to compensate the torque change due to different combustion modes and to achieve the desired rich or lean condition.

### CROSS-REFERENCE TO RELATED APPLICATION

This application claims priority to British Patent Application No. 1100883.6, filed Jan. 19, 2011, which is incorporated herein by reference in its entirety.

### TECHNICAL FIELD

The technical field relates in general to exhaust after treatment for internal combustion engines and, in particular, to a method for managing the transition between a first combustion mode and a second combustion mode in a diesel engine provided with a lean NOₓ trap.

### BACKGROUND

Diesel engines operate at higher than stoichiometric air-to-fuel mass ratios for improved fuel economy. Such “lean burning” engines produce a hot exhaust with a relatively high content of oxygen and nitrogen oxides (NOₓ). Lean NOx Trap (LNT) is one of the after treatment system that can be used to reach NOx emission target as required by legislation. This technology employs catalyst devices that catalytically oxidize nitric oxide (NO) to nitrogen dioxide (NO₂), which is then stored in a chemical trapping site as nitrate (NO₃). Once a quantity of NOₓ is absorbed by the LNT, a regeneration process is required to chemically reduce the nitrate to nitrogen to allow the LNT to trap or absorb additional NOₓ molecules.

The conventional approach to regenerate the catalyst of an LNT is temporarily introducing reducing agents, for example, by operating the lean burn internal combustion engine at rich air-to-fuel ratios. Therefore, the LNT system alternates phases of NOₓ storage (during lean engine phase, also called storage phase) with phases of release and conversion of NOₓ (during rich engine phase, also called regeneration phase).

Transition from lean to rich combustion modes, and vice versa, imply a transition from two different concepts of torque: in lean combustion mode, the torque is proportional mainly to the fuel quantity; in rich combustion mode, the maximum torque is related to air mass flow. However, a sudden switching from one combustion mode to the other, i.e., from lean to rich as well as from rich to lean, cannot be performed without causing an undesired torque variation, distinctly perceivable by the users, and undue fuel consumption.

Therefore, there is a need for a method to synchronize the switch from the two combustion modes in an efficient way. In particular, at least one object is to provide a method for managing transitions between the two different combustion modes, e.g., to pass from storage to regeneration phase and vice versa, by acting in such a way that torque change is not perceivable by the user and fuel penalty is reduced as much as possible. In addition, other objects, desirable features and characteristics will become apparent from the subsequent summary and detailed description, and the appended claims, taken in conjunction with the accompanying drawings and this background.

### SUMMARY

A method is provided for managing the transition between a first combustion mode and a second combustion mode. The method comprises: a) setting a starting value of the air mass flow during the operation of the engine in the first combustion mode as a function of the current engine conditions; b) setting a target value of the air mass flow to be reached in the second combustion mode as a function of the current engine conditions; and c) setting a transition time as a function of the current engine conditions. The method also comprises: d) setting an air mass percentage target value as a function of the current engine conditions; e) modifying the air mass flow fed to the engine according to a ramp from the starting value of the air mass flow to the target value of the air mass flow within the range of the transition time; and f) detecting the current value of the air mass flow which has been reached after step e). In addition, the method further comprises; g) providing an air mass percentage value on the basis of the value detected in step f), and the values set in steps a) and b); h) comparing the air mass percentage value provided in step g) with the air mass percentage target value set in step d) and: h1) switching the mass fuel flow to a value corresponding to the second combustion mode if the air mass percentage value provided in step g) is lower than the air mass percentage target value set in step d); or h2) otherwise repeating the steps from e) to h).

The transition between the two combustion modes can be performed without torque losses and with minimum fuel consumption, keeping at the same time the combustion as much stable as possible. It has been also found that this strategy also reduces combustion noise during transition. The values set in steps a), b) for the air mass flow, the transition time set in step c) and the air mass percentage target value set in step d) can be previously detected during experimental phases of operation of an engine, as well as evaluated/calculated by simulating the operation of an engine, and then stored in a lookup table (or map).

According to an embodiment, the engine conditions include the values of speed and torque of the engine. This is useful to optimise a transition in all the possible situations of driving. Preferably, a map of these values is previously calculated for each gear at which the values of speed and torque of the engine are detected, in order to adapt the operation of the engine to different driving conditions, e.g., urban, highway and/or mixed drive. The transition between the two combustion modes is preferably stopped if the switching conditions are not reached within the range of a predetermined time. Indeed, more is long the transition time more is difficult to control emissions and fuel consumption.

Within the range of the transition time, the air mass percentage value in step g) is provided by calculating a percentage value if: the absolute value of the difference between the current value detected in step f) and the target value set in step b) is higher than a preset constant value; or the absolute value of the difference between the starting value set in step a) and the target value set in step b) is higher than the preset constant value. This is the case in which the managing system performing the transition is still operating to reach the optimal conditions for switching the fuel path in the second combustion mode.

However, when the absolute value of the difference between the current value detected in step f) and the target value set in step b) is lower than a preset constant value, and the absolute value of the difference between the starting value set in step a) and the target value set in step b) is lower than the preset constant value, the air mass percentage value is set to a default constant value, namely a value lower than the minimum of the AirMassPercTarget values stored in the managing system. This means that the engine is already in the optimal condition for performing the hard switching of the fuel path in the second combustion mode and no further steps are required to complete the transition.

The method is suitable to apply in both the direction of the transition, i.e., a transition from a lean combustion mode to a rich combustion mode, as well as a transition from a rich combustion mode to a lean combustion mode. In both cases, if the switching conditions are not reached within the range of a predetermined time, the transition between the two combustion modes cannot be performed and the starting air mass flow is restored without affecting the fuel injection.

Another embodiment relates to an apparatus for managing the transition between a first combustion mode with a first air-to-fuel ratio and a second combustion mode with a second air-to-fuel ratio in an internal combustion engine provided with a lean NOₓ trap (50). The apparatus comprises: a) means for setting a starting value (SP(a)) of the air mass flow during the operation of the engine in said first combustion mode as a function of the current engine conditions; b) means for setting a target value (SP(b)) of the air mass flow to be reached in the second combustion mode as a function of the current engine conditions; c) means for setting a transition time (Tt_{LR}, Tt_{RL}) as a function of the current engine conditions; d) means for setting an air mass percentage target value (AirMassPercTarget) as a function of the current engine conditions; e) means for modifying the air mass flow fed to the engine (10) according to a ramp (R_{LR}, R_{RL} from the starting value (SP(a)) of the air mass flow to the target value (SP(b)) of the air mass flow within the range of the transition time (Tt_{LR}, Tt_{RL}); f) means for detecting the current value (CV(f)) of the air mass flow which has been reached after the means for modifying the air mass flow fed to the engine have modified said air mass flow; g) means for providing an air mass percentage value (AirMassPerc) on the basis of the value CV(f) and the values SP(a) and SP(b); h) means for comparing said air mass percentage value (AirMassPerc) with said air mass percentage target value (AirMassPercTarget) and: h1) means for switching the mass fuel flow to a value corresponding to said second combustion mode if said air mass percentage value (AirMassPerc) is lower than said air mass percentage target value (AirMassPercTarget); or h2) otherwise repeating to activate the means e) to h).

The transition between the two combustion modes is performed without torque losses and with minimum fuel consumption, keeping at the same time the combustion as much stable as possible. It has further found that this strategy also reduces combustion noise during transition.

An embodiment of the apparatus is configured such that the engine conditions include the values of speed and torque of the engine. This is useful to optimise a transition in all the possible situations of driving. Preferably, a map of these values is previously calculated for each gear at which the values of speed and torque of the engine are detected, in order to adapt the operation of the engine to different driving conditions, e.g., urban, highway and/or mixed drive.

Another embodiment of the apparatus is configured such that the engine conditions include the gear at which the values of speed and torque of the engine are evaluated. A further embodiment of the apparatus additionally comprises means for stopping the transition between the two combustion modes if the switching conditions are not reached within the range of a predetermined time. Still another embodiment of the apparatus comprises means for providing an air mass percentage value (AirMassPerc) which are configured to calculate a percentage value if: the absolute value of the difference between the current value (CV(f)) and the target value (SP(b)) is higher than a preset constant value; or the absolute value of the difference between the starting value (SP(a)) and the target value (SP(b)) is higher than said preset constant value.

A further embodiment has means for providing an air mass percentage value (AirMassPerc) which are configured to set the percentage value to a default constant value if: the absolute value of the difference between the current value (CV(f)) and the target value (SP(b)) is lower than a preset constant value; and the absolute value of the difference between the starting value (SP(a)) and the target value (SP(b)) is lower than said preset constant value. It is furthermore possible that the apparatus can be operated with a first air-to-fuel ratio being a lean combustion mode and with a second air-to-fuel ratio being a rich combustion mode.

Another embodiment provides an apparatus that can be operated with a first air-to-fuel ratio being a rich combustion mode and with a second air-to-fuel ratio being a lean combustion mode.

### BRIEF DESCRIPTION OF THE DRAWINGS

The present invention will hereinafter be described in conjunction with the following drawing figures, wherein like numerals denote like elements, and:

FIG. 1 is a simplified block diagram of a vehicle including an exhaust after treatment system operated according to an embodiment;

FIG. 2 is a graph that shows the operating conditions of a diesel engine in the rich combustion mode;

FIG. 3 is a schematic diagram to explain the transition phase from the lean combustion mode to the rich combustion mode according to an embodiment;

FIG. 4 is a schematic diagram to explain the transition phase from the rich combustion mode to the lean combustion mode according to an embodiment;

FIG. 5 is a flow chart of the method according to an embodiment of the present invention; and

FIG. 6 is a flow diagram of the method according to an embodiment.

### DETAILED DESCRIPTION

The following detailed description is merely exemplary in nature and is not intended to limit application and uses. Furthermore, there is no intention to be bound by any theory presented in the preceding background or summary or the following detailed description.

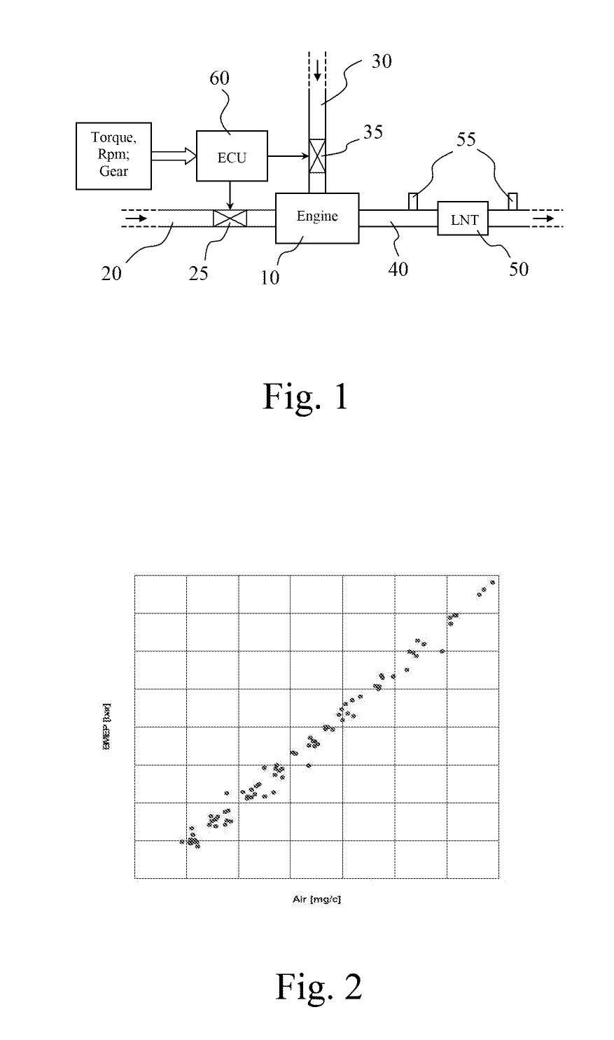

The engine 10 shown in FIG. 1 receives airflow through an air path 20 and fuel through a fuel path 30. Exhaust gases are discharged through an exhaust manifold 40 connected downstream to a lean NOₓ trap 50 (LNT) which can also be followed or preceded by other exhaust after treatment devices, such as a diesel particulate filter (DPF) or the like (not shown). A lambda probe 55 is usually installed upstream the LNT 50 and a second lambda probe 56 can be provided downstream the LNT or the DPF 70 in order to provide real time signals suitable to control the combustion processes.

An electronic control unit 60 (ECU) is programmed to control the operation of the engine 10 based on signals received by a plurality of different sensors. In order to simplify the explanation of an embodiment of the present invention, it is sufficient to take into account input signals relating to the engine conditions, in particular torque, speed and, possibly, gear, as well as output signals relating to the control of air path 20 and fuel path 30 through suitable actuators 25 and 35 respectively.

As known in this field, the regeneration technique can be based on a rich combustion phase. In lean combustion mode, the torque is proportional mainly to the fuel quantity, while in rich combustion mode the maximum torque is related to air mass flow. FIG. 2 is a plot of the almost linear dependency of BMEP (Brake Mean Effective Pressure expressed in bars), which corresponds to the specific load of the engine, with respect to air mass flow expressed in mg/cycle. Since during the transition the system is switching between the combustion mode where the torque is mainly fuel dependant to one where the torque is air mass related (or vice versa), the electronic control system 60 must be able to avoid any significant torque change that could cause undesired fuel consumption, as well as un unpleasant feeling to the users of the vehicle.

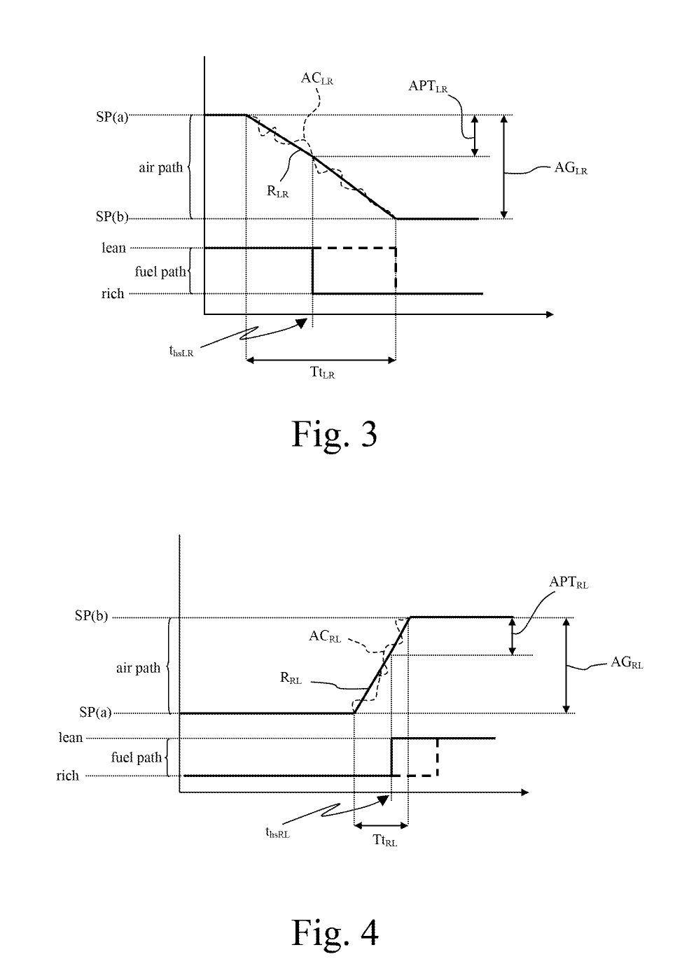

FIG. 3 shows the schematic diagrams of the transition phase from a lean combustion mode to a rich combustion mode. Once a demand of regeneration has been triggered, a starting value SP(a) and a target value SP(b) of the air mass flow are firstly set as a function of the current engine conditions. The difference between SP(a) and SP(b) determines the air goal range AG_{LR}.

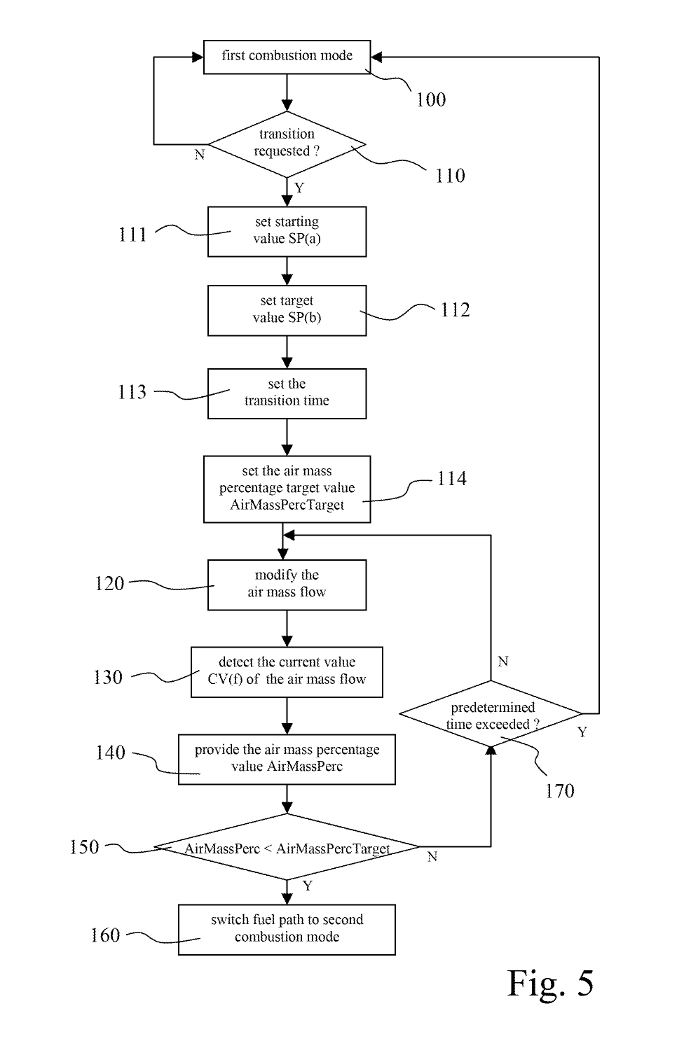

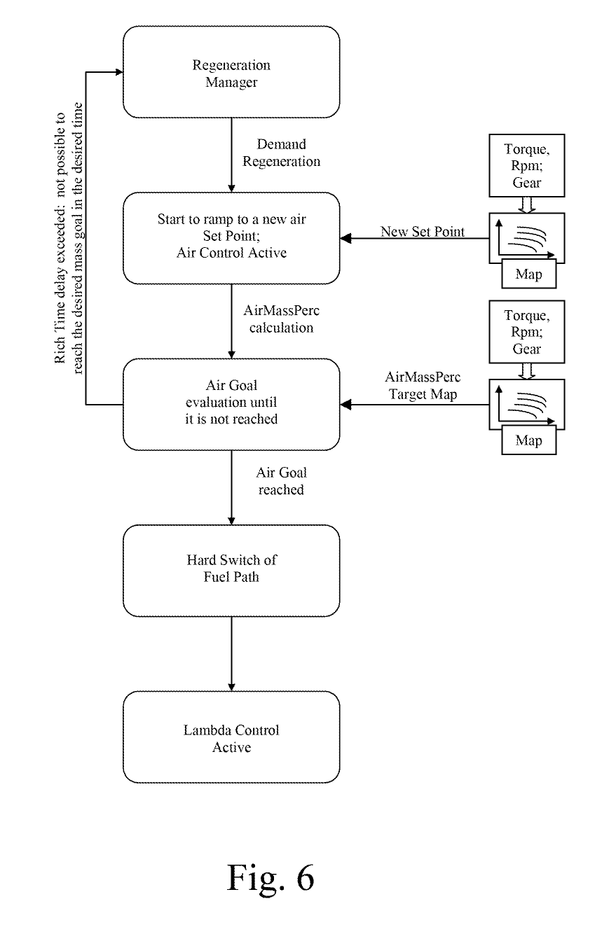

The engine conditions also determine the transition time Tt_{LR}, i.e., the range of time in which the transition must take place to satisfy the air goal, as well as a target percentage value (AirMassPercTarget in FIG. 5 and FIG. 6) to be reached to perform the transition. The transition time indicates the time spent to ramp from one set point to the other one, but it is not an indication of the physical air mass flow transition. There is another preset value indicating the maximum time to reach the air goal after that of the transition.

The ECU 60 operates the actuators 25 on the air path 20 to modify the air mass flow fed to the engine starting from the current value SP(a) and following a ramp R_{RL}: a new air mass flow value is reached. Due to changes of the engine conditions, the values could also be slightly different from those of the ramp R_{RL}: the actual curve AC_{LR} shown in dotted line in FIG. 3 is only an exemplary representation of a possible distribution of the air mass flow values during the transition time Tt_{LR}. At this point, the ECU 60 performs a check in order to state whether the conditions to complete the transition phase are verified.

An air mass percentage value is provided based on the detected air mass flow value. This percentage value (AirMassPerc in FIG. 5 and FIG. 6) is a variable able to relate a torque change to an airflow error that the system has with respect to the target value SP(b). When the absolute value of the difference between the current value detected in step f) and the target value set in step b) is higher than a preset constant value, or the absolute value of the difference between the starting value set in step a) and the target value set in step b) is higher than the preset constant value, the variable AirMassPerc is calculated as follows:

$$AirMassPerc = \frac{\vert CV ( f ) - SP ( b ) \vert}{\vert SP ( a ) - SP ( b ) \vert} * 100$$

Where: CV(f) is the current value of the air mass flow detected in step f) of the process, SP(a) is the starting value set in step a) and SP(b) is the target value of the air mass flow set in step b).

When the absolute value of the difference between the current value detected in step f) and the target value set in step b) is lower than a preset constant value, and the absolute value of the difference between the starting value set in step a) and the target value set in step b) is lower than the preset constant value, the variable AirMassPerc is set to a small constant value in order to allow anyway the transition.

The percentage value of AirMassPerc thus provided is compared to the target percentage value AirMassPercTarget that has been set as a function of the current engine conditions. This value is previously calculated and/or evaluated by simulation, for each gear, and stored in a lookup table (or map) for different conditions of speed and torque (or load) of the engine. In other words, depending on engine speed and load (and gear), the permitted variation during transitions is defined by selecting the value AirMassPercTarget, which is identified in FIG. 3 by the range APT_{LR}. If the value of AirMassPerc is lower than that of AirMassPercTarget, then the air goal is reached and so it is possible for the ECU 60 to switch immediately the fuel path 30 to the rich combustion mode at the time t_{hsLR}. If the value of AirMassPerc is higher than that of AirMassPercTarget, then the ECU 60 operates again the actuators 25 on the air path 20 to modify the air mass flow.

This cycle is repeated until the switching condition has been reached (AirMassPerc<AirMassPercTarget). If the switching conditions are not reached within the range of a predetermined time (e.g., Rich Time delay in FIG. 6), for example due to continuous modifications of the engine conditions, the transition between the lean combustion mode and the rich combustion mode cannot be performed. The ECU 60 is then set to a waiting state until a new demand of regeneration is triggered.

The adjustable duration of the ramp, i.e., the transition time, is mainly due to system time response. Depending on engine speed and load conditions, is then possible to calibrate the duration of the transitions to get the new set point target keeping the combustion as much stable as possible. Of course, more is long the transition time more will be difficult to control emissions and fuel consumption.

The same process is followed when the transition occurs between a rich combustion mode and a lean combustion mode, i.e., at the end of the regeneration phase of the LNT. In this case, as shown in FIG. 4, the starting value SP(a) and the target value SP(b) of the air mass flow are firstly set as a function of the current engine conditions. The references in FIG. 4 are the same of those of FIG. 3, except for the index LR, which is replaced by the index RL to state that these are now related to a transition from rich to lean combustion modes.

The flow chart in FIG. 5 illustrates an embodiment of the method in which it is assumed that the engine is operating in a first combustion mode (block 100) until a request for transition is detected at the decision block 110. At the start of the transition, the starting value SP(a) and the target value SP(b) of the air mass flow, as well as the transition time Tt_{LR} (or Tt_{RL}) and the AirMassPercTarget, are firstly set in the ECU 60 (blocks 111, 112, 113 and 114 respectively) by reading the corresponding values from lookup table(s) already stored with values depending on the current engine conditions

At block 120, the air flow actuators 25 are then operated to modify the air mass flow fed to the engine 10 according to a ramp R_{LR} (or R_{RL}), which extends from the starting value SP(a) to the target value SP(b) within the range of the transition time.

After operating the airflow actuators 25, the current value CV(f) of the air mass flow is detected at block 130 in order to have a measure of the new condition reached after modifying the air mass flow. The parameter AirMassPerc that indicates the new condition of the transition process is a percentage value provided at block 140 and then compared in the decision block 150 with the value AirMassPercTarget previously set in block 114 at the start of the transition phase.

If the value of AirMassPerc is lower than the value AirMassPercTarget, the mass fuel flow is suddenly switched to a value corresponding to the second combustion mode and the transition phase is completed (block 160). If the value of AirMassPerc is still higher than the value AirMassPercTarget, a check is performed to determine whether a predetermined time for performing the transition has been exceeded (decision block 170). In the positive, the transition is stopped and the control flow goes back to block 100 to continue the operation of the engine in the first combustion mode. Otherwise, the control flow goes back to block 120 to continue the transition phase.

In summary, after a regeneration demand/start, or at the end of the regeneration phase, air path actuators 25 follow the new set point SP(b) ramped from the old value SP(a) to the new one in a predetermined transition time depending on the engine conditions. It is assumed that the regeneration phase starts at the regeneration demand. When the air mass percentage value reaches the desired target, which is a function of engine speed, load and gear, then a prefixed air goal is reached. Fuel path actuators 35 are then suddenly switched to compensate the torque change due to different combustion conditions and to achieve the desired rich or lean condition.

A high-level overview of the control logic to manage the air goal concept according to an embodiment of the present invention is shown in FIG. 6 for the transition process from a lean combustion mode to a rich combustion mode. Even if not expressly stated above, the lambda control during the transition phase is preferably excluded because the values possibly detected would be meaningless. When the transition is completed, i.e., after the “hard switch” of the fuel path has been performed, the lambda control is newly activated to monitor the steady condition of lean (or rich) combustion.

In summary, the control strategy according to an embodiment of the present invention shall be able to detect the correct amount of air for switching, for example, from a lean combustion mode to a rich combustion mode in order to: get the rich atmosphere to regenerate LNT: this is done thanks to the hard switch synchronized to, the reduced air flow using the air goal concept. Switching fuel after reducing air mass flow leads to reduced fuel consumption; have a stable air mass flow: the transition is done only when the air flow is stable to avoid unwanted torque drop; do not feel a torque drop between rich and lean mode, since torque is proportional before to fuel quantity and after is limited by air mass flow. By calibrating the air goal is possible to estimate the permitted torque drop during fuel transition and so to control it; optimize the contribute of lambda control to avoid big fuel consumption increase. This is achieved thanks to the fact that the lambda control is switched on only when all the injection pattern has been switched and the air path is near the rich target.

The embodiments of the method described above may be carried out with the help of a computer program comprising a program code or computer readable instructions for carrying out all the method steps described above. The computer program can be stored on a data carrier or, in general, a computer readable medium or storage unit, to represent a computer program product. The storage unit may be a CD, DVD, a hard disk, a flash memory, or the like. The computer program can be also embodied as an electromagnetic signal, the signal modulated to carry a sequence of data bits that represent a computer program to carry out all steps of the methods. The computer program may reside on or in a data carrier, e.g. a flash memory, which is data connected with a control apparatus for an internal combustion engine. The control apparatus has a microprocessor that receives computer readable instructions in form of parts of said computer program and executes them. Executing these instructions amounts to performing the steps of the method as described above, either wholly or in part.

The electronic control unit 60 or, in general, an ECA (Electronic Control Apparatus) can be a dedicated piece of hardware such as an ECU (Electronic Control Unit), which is commercially available and thus known in the art, or can be an apparatus different from such an ECU, e.g., an embedded controller. If the computer program is embodied as an electromagnetic signal as described above, then the electronic control apparatus, e.g. the ECU or ECA, has a receiver for receiving such a signal or is connected to such a receiver placed elsewhere. A programming robot in a manufacturing plant may transmit the signal. The bit sequence carried by the signal is then extracted by a demodulator connected to the storage unit, after which the bit sequence is stored on or in said storage unit of the ECU or ECA.

While at least one exemplary embodiment has been presented in the foregoing summary and detailed description, it should be appreciated that a vast number of variations exist. It should also be appreciated that the exemplary embodiment or exemplary embodiments are only examples, and are not intended to limit the scope, applicability, or configuration in any way. Rather, the foregoing summary and detailed description will provide those skilled in the art with a convenient road map for implementing at least one exemplary embodiment, it being understood that various changes may be made in the function and arrangement of elements described in an exemplary embodiment without departing from the scope as set forth in the appended claims and their legal equivalents.

What is claimed is:

1. A method for managing a transition between a first combustion mode with a first air-to-fuel ratio and a second combustion mode with a second air-to-fuel ratio in an internal combustion engine provided with a lean NOₓ trap, the method comprising:
setting a starting value of an air mass flow during operation of the internal combustion engine in said first combustion mode as a function of current engine conditions;
setting a target value of the air mass flow to reach in the second combustion mode as a function of the current engine conditions;
setting a transition time as a function of the current engine conditions;
setting an air mass percentage target value as a function of the current engine conditions;
modifying the air mass flow fed to the internal combustion engine according to a ramp from the starting value of the air mass flow to the target value of the air mass flow within a range of the transition time;
detecting a current value of the air mass flow which has been reached after the modifying the air mass flow fed to the internal combustion engine;
providing an air mass percentage value based on the current value and the starting value and the target value;
comparing said air mass percentage value with said air mass percentage target value; and
switching a mass fuel flow to a value corresponding to said second combustion mode if said air mass percentage value provided is lower than said air mass percentage target value.

2. The method according to claim 1, wherein said engine conditions comprise speed values and torque values of the internal combustion engine.

3. The method according to claim 1, further comprising evaluating the speed values and torque values of the internal combustion engine at a gear, wherein the engine conditions comprise the gear.

4. The method according to claim 1, wherein the transition between the first combustion mode and the second combustion mode is stopped if switching conditions are not reached within the range of a predetermined time.

5. The method according to claim 1, further comprising calculating a percentage value if a absolute value of a difference between the current value and the target value is higher than a preset constant value.

6. The method according to claim 1, further comprising calculating a percentage value if an absolute value of a difference between the starting value and the target value is higher than a preset constant value.

7. The method according to claim 1, further comprising setting a percentage value to a default constant value if a absolute value of a difference between the current value and the target value is lower than a preset constant value, and the absolute value of a difference between the starting value and the target value is lower than said preset constant value.

8. The method according to claim 1, wherein said first combustion mode with the first air-to-fuel ratio is a lean combustion mode and said second combustion mode with the second air-to-fuel ratio is a rich combustion mode.

9. The method according to claim 1, wherein said first combustion mode with the first air-to-fuel ratio is a rich combustion mode and said second combustion mode with the second air-to-fuel ratio is a lean combustion mode.

10. A computer readable medium embodying a computer program product, said computer program product, comprising:
a management program for managing a transition between a first combustion mode with a first air-to-fuel ratio and a second combustion mode with a second air-to-fuel ratio in an internal combustion engine provided with a lean NOₓ trap, the management program configured to:
set a starting value of an air mass flow during operation of the internal combustion engine in said first combustion mode as a function of current engine conditions;
set a target value of the air mass flow to reach in the second combustion mode as a function of the current engine conditions;
set a transition time as a function of the current engine conditions;
set an air mass percentage target value as a function of the current engine conditions;
modify the air mass flow fed to the internal combustion engine according to a ramp from the starting value of the air mass flow to the target value of the air mass flow within a range of the transition time;
detect a current value of the air mass flow that has been reached after the modifying the air mass flow fed to the internal combustion engine;
provide an air mass percentage value based on the current value and the starting value and the target value;
compare said air mass percentage value with said air mass percentage target value; and
switch a mass fuel flow to a value corresponding to said second combustion mode if said air mass percentage value provided is lower than said air mass percentage target value.

11. The computer readable medium embodying the computer program product, said computer program product according to claim 10, wherein said engine conditions comprise speed values and torque values of the internal combustion engine.

12. The computer readable medium embodying the computer program product, said computer program product according to claim 10, the management program further configured to evaluate the speed values and torque values of the internal combustion engine at a gear, wherein the engine conditions comprise the gear.

13. The computer readable medium embodying the computer program product, said computer program product according to claim 10, wherein the transition between the first combustion mode and the second combustion mode is stopped if switching conditions are not reached within the range of a predetermined time.

14. The computer readable medium embodying the computer program product, said computer program product according to claim 10, the management program further configured to calculate a percentage value if an absolute value of a difference between the current value and the target value is higher than a preset constant value.

15. The computer readable medium embodying the computer program product, said computer program product according to claim 10, the management program further configured to calculate a percentage value if an absolute value of a difference between the starting value and the target value is higher than a preset constant value.

16. The computer readable medium embodying the computer program product, said computer program product according to claim 10, the management program further configured to set a percentage value to a default constant value if an absolute value of a difference between the current value and the target value is lower than a preset constant value, and the absolute value of a difference between the starting value and the target value is lower than said preset constant value.

17. The computer readable medium embodying the computer program product, said computer program product according to claim 10, wherein said first combustion mode with the first air-to-fuel ratio is a lean combustion mode and said second combustion mode with the second air-to-fuel ratio is a rich combustion mode.

18. The computer readable medium embodying the computer program product, said computer program product according to claim 10, wherein said first combustion mode with the first air-to-fuel ratio is a rich combustion mode and said second combustion mode with the second air-to-fuel ratio is a lean combustion mode.
